(19) United States
(12) Patent Application Publication
(10) Pub. No.: US 2026/0231019 A1
(43) Pub. Date: Aug. 6, 2026

(54) ENERGY EFFICIENT SCHEDULING FOR MULTI-CONNECTION COMMUNICATIONS

(71) Applicant: QUALCOMM Incorporated, San Diego, CA (US)

(72) Inventors: Diana MAAMARI, San Diego, CA (US); Gabi SARKIS, San Diego, CA (US); Kianoush HOSSEINI, San Diego, CA (US); Hari SANKAR, San Diego, CA (US); Jing JIANG, San Diego, CA (US)

(21) Appl. No.: 19/042,687

(22) Filed: Jan. 31, 2025

(51) Int. Cl. H04W 52/02

(52) U.S. Cl. CPC H04W 52/0216

(57) ABSTRACT

Methods, systems, and devices for wireless communications are described. A user equipment (UE) may communicate, via a first connection and a second connection, with one or more network entities, where communications via the second connection are in accordance with an energy-saving mode. The UE may further transmit, to at least one network entity of the one or more network entities, control signaling to align respective communications modes for the first connection and the second connection, where alignment of the respective communications modes includes communications via the first connection and the communications via the second connection both being in accordance or not being in accordance with the energy-saving mode. The UE may then communicate, via the first connection and the second connection, with the one or more network entities in accordance with the alignment of the respective communications modes for the first connection and the second connection.

### FIELD OF TECHNOLOGY

The following relates to wireless communications, including energy efficient scheduling for multi-connection communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include communicating, via a first connection and a second connection, with one or more network entities, where communications via the second connection are in accordance with an energy-saving mode, transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode, and communicating, via the first connection and the second connection, with the one or more network entities in accordance with the alignment of the respective communications modes for the first connection and the second connection.

A UE for wireless communications is described. The UE may include one or more memories storing processor executable code, a transceiver, and one or more processors coupled with the one or more memories and the transceiver. The one or more processors may individually or collectively be operable to execute the code to cause the UE to communicate, via the transceiver and via a first connection and a second connection, with one or more network entities, where communications via the second connection are in accordance with an energy-saving mode, transmit, via the transceiver, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode, and communicate, via the transceiver and via the first connection and the second connection, with the one or more network entities in accordance with the alignment of the respective communications modes for the first connection and the second connection.

Another UE for wireless communications is described. The UE may include means for communicating, via a first connection and a second connection, with one or more network entities, where communications via the second connection are in accordance with an energy-saving mode, means for transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode, and means for communicating, via the first connection and the second connection, with the one or more network entities in accordance with the alignment of the respective communications modes for the first connection and the second connection.

A non-transitory computer-readable medium storing code for wireless communications is described. The code may include instructions executable by one or more processors to communicate, via a first connection and a second connection, with one or more network entities, where communications via the second connection are in accordance with an energy-saving mode, transmit, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode, and communicate, via the first connection and the second connection, with the one or more network entities in accordance with the alignment of the respective communications modes for the first connection and the second connection.

In some examples of the method, UEs, and non-transitory computer-readable medium described herein, operations, features, means, or instructions for transmitting transmit the control signaling to align the respective communications modes ma include operations, features, means, or instructions for transmitting, to a network entity associated with the second connection, an indication of a capability of the UE to exit the energy-saving mode for the second connection based on a change from a first communication state for the first connection to a second communication state for the first connection, the alignment of the respective communications modes including the communications via the first connection and the communications via the second connection both not being in accordance with the energy-saving mode based on an exit of the energy-saving mode for the second connection.

In some examples of the method, UEs, and non-transitory computer-readable medium described herein, the first communication state is a radio resource control (RRC) idle state or an RRC inactive state, and the second communication state is an RRC connected state.

In some examples of the method, UEs, and non-transitory computer-readable medium described herein, the alignment of the respective communications modes is associated with an applicability time for the capability of the UE to exit the energy-saving mode for the second connection.

In some examples of the method, UEs, and non-transitory computer-readable medium described herein, operations, features, means, or instructions for transmitting transmit the control signaling to align the respective communications modes ma include operations, features, means, or instructions for transmitting, to the at least one network entity of the one or more network entities, an uplink assistance information message, an uplink control information message, a medium access control (MAC)-control element (CE) message, a random access message, or any combination thereof.

In some examples of the method, UEs, and non-transitory computer-readable medium described herein, operations, features, means, or instructions for transmitting transmit the control signaling to align the respective communications modes ma include operations, features, means, or instructions for transmitting, to a network entity associated with the first connection, an indication that the communications via the second connection are in accordance with the energy-saving mode.

In some examples of the method, UEs, and non-transitory computer-readable medium described herein, operations, features, means, or instructions for transmitting transmit the control signaling to align the respective communications modes ma include operations, features, means, or instructions for transmitting configuration information for the energy-saving mode, the configuration information for the energy-saving mode indicating a feedback timeline for the second connection, one or more active periods during which the UE is available to be scheduled for one or more shared channel communications via the second connection, one or more scheduling gaps during which the UE is not to be scheduled for shared channel communications via the second connection, or any combination thereof.

In some examples of the method, UEs, and non-transitory computer-readable medium described herein, the UE is also unavailable to be scheduled for one or more shared channel communications via the first connection during the one or more scheduling gaps.

In some examples of the method, UEs, and non-transitory computer-readable medium described herein, the UE is available to be scheduled for one or more shared channel communications via the first connection during the one or more scheduling gaps based on a throughput threshold for the first connection.

In some examples of the method, UEs, and non-transitory computer-readable medium described herein, operations, features, means, or instructions for transmitting transmit the control signaling to align the respective communications modes ma include operations, features, means, or instructions for transmitting, to the at least one network entity, an indication of a duty cycle including one or more periods during which the UE is not to be scheduled for shared channel communications via the first connection.

In some examples of the method, UEs, and non-transitory computer-readable medium described herein, the energy-saving mode indicates a scheduling configuration that is associated with a first active period during which the UE is scheduled to receive one or more shared channel communications, one or more scheduling gaps that occur after the first active period and during which the UE is not to be scheduled for shared channel communications, and a second active period that occurs after the one or more scheduling gaps.

In some examples of the method, UEs, and non-transitory computer-readable medium described herein, the alignment for the communications via the first connection and the communications via the second connection to both be in accordance with the energy-saving mode is associated with an applicability time, a timer duration, or both that are based on a time of transmission of the control signaling.

In some examples of the method, UEs, and non-transitory computer-readable medium described herein, the first connection is associated with a first service subscription and the second connection is associated with a second service subscription.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of a wireless communications system that support energy efficient scheduling for multi-connection communications in accordance with one or more aspects of the present disclosure.

FIG. 3 show examples of timing diagrams that support energy efficient scheduling for multi-connection communications in accordance with one or more aspects of the present disclosure.

FIG. 4 shows an example of a process flow that supports energy efficient scheduling for multi-connection communications in accordance with one or more aspects of the present disclosure.

FIGS. 5 and 6 show block diagrams of devices that support energy efficient scheduling for multi-connection communications in accordance with one or more aspects of the present disclosure.

FIG. 7 shows a block diagram of a communications manager that supports energy efficient scheduling for multi-connection communications in accordance with one or more aspects of the present disclosure.

FIG. 8 shows a diagram of a system including a device that supports energy efficient scheduling for multi-connection communications in accordance with one or more aspects of the present disclosure.

FIG. 9 shows a flowchart illustrating methods that support energy efficient scheduling for multi-connection communications in accordance with one or more aspects of the present disclosure.

### DETAILED DESCRIPTION

In some wireless communication systems, a user equipment (UE) may enter various power modes associated with throughput and scheduling considerations. For example, for high throughput and wideband scheduling communications, the UE may enter a high power state. In some examples, the UE may operate in a reduced power state, which may alternatively be referred to as a reduced capability mode or reduced peak throughput mode. For example, a UE may communicate in a wideband and a peak throughput may be reduced by configuring one or more slots as scheduling gaps in which the UE may expect to not be scheduled with downlink communications or uplink or both. Such scheduling gaps may allow the UE to remain in a relatively lower power state, despite the bursts of higher throughput wideband scheduling (e.g., by allowing the UE extra time, during a gap, to perform processing associated with communications received before the gap or to be transmitted after the gap). Thus, in such a reduced power state, which may alternatively be referred to as an example of an energy-saving state or mode or as an energy-efficient scheduling state or mode or reduced capability mode or reduced throughput mode, the UE is scheduled for wideband communications but in a bursty fashion with gaps between communications, where during those gaps (e.g., slots, symbols, or other types of transmission time intervals) the UE does not expect certain channels or signals to be scheduled. In addition to the indication of gaps and intermittent scheduling, the UE may also be indicated a relaxation in the processing timeline of data messages, wideband reference signals, or both. Relaxation of the processing timeline may include or otherwise be associated with a relaxation of feedback timeline (an increased offset from a time of receipt of a downlink shared channel message to transmission of a corresponding uplink control channel message, such as an acknowledgment message).

In some cases, a UE may be capable of communicating with network entities via two or more connections. For example, the UE may communicate with a network entity via a first connection and with a network entity (e.g., the same or a different network entity used for the first connection) via a second connection. In some examples, the UE may operate within a first communication mode via the first connection and within a second communication mode via the second connection where the second communication mode is associated with an energy-saving or reduced capability mode. However, a network entity associated with the first connection may operate as if both connections are within the first communication mode (e.g., not within the energy-saving mode) and the network entity may schedule the UE at full capability mode (scheduled at all times with no gaps, no relaxation in processing timelines, no relaxation in feedback timeline) thus resulting in the energy-saving mode of the second connection being unable to perform and provide efficient energy savings for the wireless communications system.

In accordance with the techniques of the present disclosure, a UE may perform one or more operations to align communications between connections of the UE. For example, a UE may attempt to move from between communication states (e.g., from an idle or inactive state to an active state) on a first connection and the UE may be limited by throughput based on a second connection being associated with an energy-saving mode. In such example, the UE may indicate for a network entity associated with the second connection to exit (e.g., leave) the energy-saving mode. In another example, the UE may indicate for a network entity associated with the first connection (e.g., the connection operating outside of the energy-saving mode) to adjust the communications of the connection to refrain from exceeding a throughput threshold that is based on the second connection being within an energy-saving mode. In some cases, to perform such operations (e.g., exiting an energy-saving mode or adjusting communications to comply with an energy-saving mode), the UE may transmit control signaling to at least one of the network entities associated with one of the connections to align respective communication modes of the first connection and the second connection. Therefore, in accordance with the techniques of the present disclosure, UEs may be capable of communicating with two or more connections in accordance with an alignment to ensure reliable and efficient communications within the wireless communications system. For example, the UE can coordinate (e.g., with one or more network entities via uplink signaling) to align the two connections to either both be in the energy-saving scheduling mode (e.g., by telling a network entity associated with a newly active connection that the UE is restricted to the scheduling energy-saving scheduling mode) or to both not be in the energy-saving scheduling mode (e.g., by telling a network entity associated with a pre-existing connection that the UE can exit the scheduling energy-saving scheduling mode).

Aspects of the disclosure are initially described in the context of wireless communications systems. Additional aspects of the disclosure are described with reference to a wireless communications system, timing diagrams, and a process flow. Aspects of the disclosure are further illustrated by and described with reference to apparatus diagrams, system diagrams, and flowcharts that relate to energy efficient scheduling for multi-connection communications.

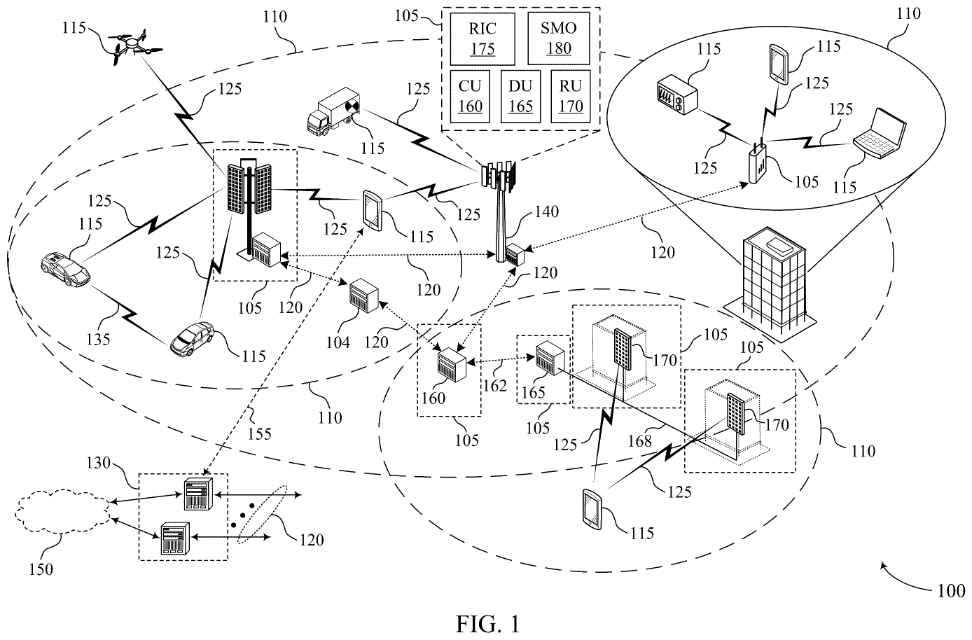

FIG. 1 shows an example of a wireless communications system 100 that supports energy efficient scheduling for multi-connection communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support energy efficient scheduling for multi-connection communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple CCs.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may operate in accordance with energy efficient scheduling (e.g., an energy-saving mode). In accordance with the energy-saving mode, to reduce the energy consumption of a UE 115, a UE 115 may be able to receive burst of wideband signaling while remaining in a relatively low power (e.g., while remaining in a power state normally associated with more narrowband signaling, without entering a higher power state). For example, the throughput of downlink data may be relatively less than a peak throughput level and the UE 115 may be scheduled with gaps (e.g., scheduling gaps) that are guaranteed between downlink communications (e.g., physical downlink shared channel (PDSCH) communications). Thus, the UE 115 may be configured (e.g., based on a UE 115 determination or by a network entity 105) to relax a feedback timeline to reduce energy consumption.

In some cases, for high throughput and wideband scheduling, a UE 115 may enter a highest possible power state. For example, in the wireless communications system 100, a UE 115 may adjust an internal baseband to a relatively higher-power state when the UE 115 moves to utilizing wideband scheduling. Thus, to allow a UE 115 to remain in a relatively lower-power state while still receiving wideband signaling, a network entity 105 may indicate that the network entity 105 will refrain from scheduling the UE 115 with a sustained peak throughput. For example, the network entity 105 may guarantee to the UE 115 that the network entity 105 will refrain from scheduling communications that exceeds a throughput threshold (e.g., the maximum scheduled throughput will not exceed a limit), guarantee that a feedback timeline for the UE 115 can be relaxed, and guarantee that there will be one or more gaps between downlink communications (e.g., PDSCHs). Within a relaxed feedback timeline, a UE 115 may expect to have one or more periods of at least a threshold duration to process downlink communications before transmitting a feedback indication (e.g., transmitting a HARQ-acknowledgment or negative acknowledgment (HARQ-ACK/NACK)), which may allow the UE 115 to remain in the relatively low power state while still transmitting feedback messages in a timely manner.

In some cases, UEs 115 communication within the wireless communications system 100 may be subject to a peak throughput data rate as illustrated via Equation 1 below.

$$data rate = {10}^{- 6} * {\sum }_{j = 1}^{j} ( {v}_{Layers}^{( j )} * {Q}_{m}^{( j )} * {f}^{( j )} * {R}_{max} * \frac{{N}_{PRB}^{BW ( j ) , μ} * 12}{{T}_{s}^{μ}} * ( 1 - {OH}^{( j )} ) ) \qquad ( 1 )$$

The peak data rate may be based on a sum, for every CC index (e.g., for every j-th CC), of a product of a maximum quantity of layers

$$( e . g . , {v}_{Layers}^{( j )} ) ,$$

a maximum modulation order

$$( e . g . , {Q}_{m}^{( j )} ) ,$$

a scaling factor (e.g., f^{(j)}, a maximum code rate

$$( e . g . , {R}_{max} = \frac{948}{1024} ) ,$$

a quotient

$$( e . g . , \frac{{N}_{PRB}^{BW ( j ) , μ} * 12}{{T}_{s}^{μ}} )$$

of a maximum quantity of resource blocks

$$( e . g . , {N}_{PRB}^{BW ( j ) , μ} )$$

multiplied by quantity of subcarriers or resource blocks (e.g., 12) and an average OFDM symbol duration

$$( e . g . , {T}_{s}^{μ} ) ,$$

and one subtracted from an overhead value (e.g., OH^{(j)} that is based on a frequency range and whether the data rate is for downlink or uplink communications.

For energy efficient scheduling (e.g., communications in accordance with an energy-saving mode), a network entity 105 may indicate or signal (e.g., transmit) an additional scaling factor (e.g., z^{(j)}) to a UE 115, such as the additional scaling factor z^{(j)} shown in Equation 2 below, in which a value of z^{(j)} greater than a value of 1 (e.g., z^{(j)}>1) corresponds to a reduced peak throughput rate. The network entity 105 may also indicate a processing timeline relaxation to the UE 115 where the UE 115 may have N1+X msec to process downlink communications (e.g., a feedback timeline may also be relaxed). Moreover, the scaling factor and the processing timeline relaxation may be based on a discontinuous reception (DRX) after a last PDSCH to limit a de-mapper and decoder overload. The network entity 105 may also indicate one or more DRX slots between PDSCHs that are gap slots that the network entity 105 should refrain from scheduling PDSCHs during. Additionally, or alternatively, the UE 115 may indicate a quantity of PDSCHs that can be scheduled back-to-back before a scheduling or DRX gap is expected. Thus, based on the union of gaps, the network entity 105 may ensure that a UE 115 is capable of communicating via energy efficient scheduling DRX. Further, a UE 115 that is scheduled in the energy-saving mode can be configured with a reduced peak throughput data rate based on the indicated value of the scaling factor (e.g., z^{(j)}) as shown in Equation 2 below.

$$data rate = {10}^{- 6} * {\sum }_{j = 1}^{j} ( {v}_{Layers}^{( j )} * {Q}_{m}^{( j )} * {f}^{( j )} * {R}_{max} * \frac{{N}_{PRB}^{BW ( j ) , μ} * 12}{{z}^{( j )} * {T}_{s}^{μ}} * ( 1 - {OH}^{( j )} ) ) \qquad ( 2 )$$

In some examples of the wireless communications system 100, a UE 115 may communicate via two or more connections (e.g., via two or more communication links 125). For example, a UE 115 may communicate with one or more network entities 105 on a first connection that is associated with a first service (e.g., a first service subscription, a first network provider) and on a second connection that is associated with a second service (e.g., a second service subscription, a second network provider). In some examples, in accordance with the techniques of the present disclosure, a UE 115 may perform one or more operations to align communications between connections of the UE 115. For example, a UE 115 may attempt to move from between communication states (e.g., from an idle or inactive state to an active state) on a first connection and the UE 115 may be limited by throughput based on a second connection being associated with an energy-saving mode. In such example, the UE 115 may indicate for a network entity 105 associated with the second connection to exit (e.g., leave) the energy-saving mode. In another example, the UE 115 may indicate for a network entity 105 associated with the first connection (e.g., the connection operating outside of the energy-saving mode) to adjust the communications of the connection to refrain from exceeding a throughput threshold that is based on the second connection being within an energy-saving mode.

In some cases, to perform such operations (e.g., exiting an energy-saving mode or adjusting communications to comply with an energy-saving mode), the UE 115 may transmit control signaling to at least one of the network entities 105 associated with one of the connections to align respective communication modes of the first connection and the second connection. Therefore, in accordance with the techniques of the present disclosure, UEs 115 may be capable of communicating with two or more connections in accordance with an alignment to ensure reliable and efficient communications within the wireless communications system 100.

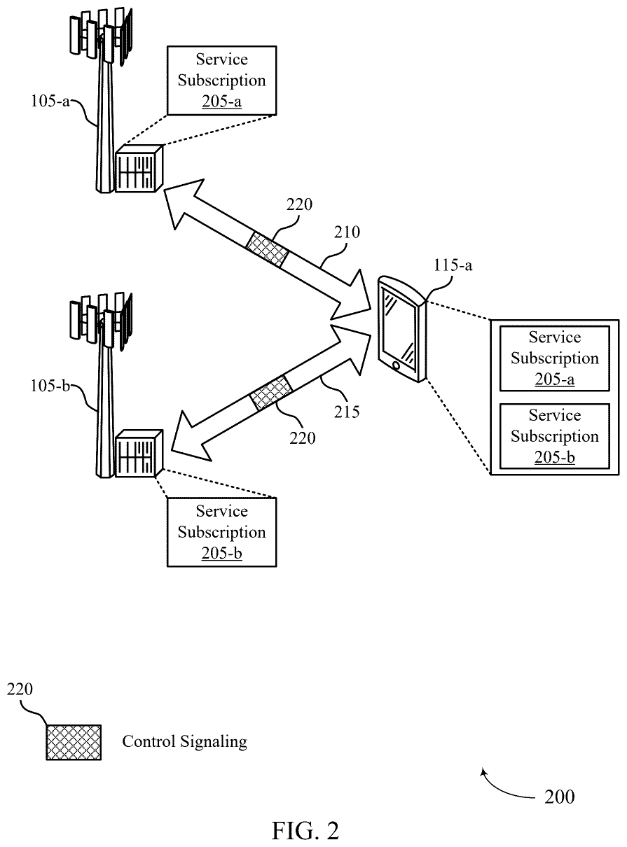

FIG. 2 shows an example of a wireless communications system 200 that supports energy efficient scheduling for multi-connection communications in accordance with one or more aspects of the present disclosure. In some examples, the wireless communications system 200 may implement or be implemented by the wireless communications system 100. For example, the wireless communications system 200 may include a network entity 105-a associated with a service subscription 205-a, a network entity 105-b associated with a service subscription 205-b, and a UE 115-a associated with both the service subscription 205-a and the service subscription 205-b, which may represent examples of corresponding devices described herein with reference to FIG. 1. The network entity 105-a and the UE 115-a may communicate via a connection 210 that is associated with the service subscription 205-a and the network entity 105-b and the UE 115-a may communicate via a connection 215 that is associated with the service subscription 205-b. The connection 210 and the connection 215 may be examples of a communication link 125 such as a Uu link, a sidelink, a backhaul link, a D2D link or some other type of communication link 125 described herein with reference to FIG. 1.

In some examples, the UE 115-a may be configured with multiple service subscriptions 205 (e.g., the service subscription 205-a and the service subscription 205-b). In some cases, a service subscription 205 may also be referred to as a subscriber identity module (SIM) such that the UE 115 is configured with multiple SIMs (e.g., a first SIM associated with the service subscription 205-a and a second SIM associated with the service subscription 205-b). For example, a UE 115-a may be configured with multiple physical or virtual SIM cards that enable the UE 115 to communicate via respective service subscriptions 205.

A service subscription 205 may indicate a network provider or wireless service provider for the UE 115-a. That is, a service subscription 205 may be associated with an organization, company, or vendor that provides UEs 115 and other wireless devices connections to the wireless communications system 200. In some cases, each service subscription 205 may be associated with a different network entity 105. Further, the network entity 105-b may provide connections (e.g., a connection 215) to UEs 115 (e.g., the UE 115-a) and other wireless devices that are associated with, supported by, or configured by the service subscription 205-b. Additionally, or alternatively, a network entity 105 may be associated with multiple service subscriptions 205. For example, a network entity 105 may be associated with both the service subscription 205-a and the service subscription 205-b and may communicate with the UE 115-a over the connection 210 in accordance with service subscription 205-a and over the connection 215 in accordance with service subscription 205-b. Additionally, or alternatively, the techniques of the present disclosure described herein related to the multiple service subscriptions 205 may also be applied for dual connectivity for master cell groups (MCGs) and secondary cell groups (SCGs) or master node (MN) and secondary node (SN) coordination. For example, the UE 115-a may be associated with a multi-radio dual connectivity (MR-DC) architecture where the UE 115-a can be connected to multiple different RAN nodes at the same time in a similar fashion as being connected to multiple different service subscriptions 205.

In some examples, to support the communications via both the connection 210 associated with the service subscription 205-a and the connection 215 associated with the service subscription 205-b, the UE 115-a may be a dual SIM dual standby (DSDS) UE 115. DSDS may be a configuration that enables a UE 115 (e.g., the UE 115-a) to be configured with two independent service subscriptions 205 (e.g., the service subscription 205-a and the service subscription 205-b) on the network at the same time. However, when one of the two service subscriptions 205 are active, the other service subscription 205 may be inactive and transition to be out-of-service. Thus, when the UE 115-a communicates with a network entity 105 using the service subscription 205-a, the service subscription 205-b may be inactive and go into an out-of-service state. For example, the UE 115-a may utilize the service subscription 205-a for a voice call and communicate with the network entity 105-a that is associated with the service subscription 205-a via the connection 210 and the service subscription 205-b along with the connection 215 with the network entity 105-b associated with the service subscription 205-b may go out of service or be disconnected. In some cases, a connection going out of service may be associated with the UE 115-a transitioning from a radio resource control (RRC) active state to an RRC idle state or an RRC inactive state.

In some other examples, the UE 115-a may be a dual SIM dual active (DSDA) UE 115. DSDA may be a configuration that enables a UE 115 (e.g., the UE 115-a) to be configured with two independent service subscriptions 205 (e.g., the service subscription 205-a and the service subscription 205-b) that the UE 115 can utilize at the same time. For example, the UE 115-a may use the service subscription 205-a for a voice call and the UE 115-a may be capable of using the service subscription 205-b for additional operations at the same time as the voice call on the service subscription 205-a. That is, the UE 115-a may be capable of communicating with the network entity 105-a via the connection 210 using the service subscription 205-a or with the network entity 105-b via the connection 215 using the service subscription 205-b and the other service subscription 205 and corresponding connection may remain in service (e.g., within an RRC active state). Additionally, or alternatively, if the UE 115-a is a full-duplex UE 115, the UE 115-a may communicate with the network entity 105-a via the connection 210 using the service subscription 205-a at the same time as communicating with the network entity 105-b via the connection 215 using the service subscription 205-b.

In some cases, the UE 115-a may transmit an indication of a capability restriction to the network entity 105-a, the network entity 105-b, or both. For example, to establish an energy-saving mode with a respective network entity 105, the UE 115-a may transmit an indication to respective network entity 105 during an RRC setup procedure or RRC resume procedure (e.g., a procedure of transitioning from an RRC idle to an RRC active state) that the UE 115-a is within a reduced capability mode. Thus, the respective network entity 105 may schedule the UE 115-a relatively more conservatively until the UE 115-a reports (e.g., transmits) additional information related to the capabilities of the UE 115-a.

In some examples, the UE 115-a may transmit an uplink assistance information (UAI) message to a network entity 105 (e.g., the network entity 105-a, the network entity 105-b, or both) to indicate one or more changes in the capabilities of the UE 115-a. In some cases, the UE 115-a may be proactive about the indication and transmit the UAI message to indicate the capability changes for parameters which have yet to be configured (e.g., parameters for non-serving cells). In some other cases, the UE 115-a may be reactive about the indication and may request capability changes for current RRC configurations. In some examples, via the UAI message, the UE 115-a may request for a maximum MIMO layer or bandwidth restriction. The restriction may be per downlink or uplink of each cell or per band. Moreover, the maximum MIMO layers or bandwidth within a band may correspond to the maximum MIMO layers or bandwidth on each CC within the band. In another example, the UE 115-a may request for one or more serving cells to be released from both a master cell group (MCG) and a secondary cell group (MCG). In some cases, the UE 115-a may transmit such request based on one or more cells or bands associated with a first network (e.g., the service subscription 205-a) conflicting with resources on a second network (e.g., the service subscription 205-b). Additionally, or alternatively, the UE 115-a may indicate for a temporary maximum quantity of CCs per downlink, uplink, or both. In some cases, the UE 115-a may transmit such request separately or together for different frequency ranges (e.g., separately or together for frequency range (FR) 1 (FR1) and FR2). Further, the UE 115-a may determine whether to transmit such request per-FR level, per UE 115 level, or both.

Based on such requests, the UE 115-a may be configured with an efficient scheduling configuration to achieve energy savings while allowing the UE 115-a to refrain from entering a higher power state. Such energy savings may be accomplished through a guaranteed reduced peak throughput during unscheduled time slots and a relaxed (e.g., longer, extended) feedback timeline. Further, as illustrated herein, the UE 115-a may be a dual transmission and reception capable UE 115 (e.g., a full-duplex UE 115) that is able to transmit and receive communications on two different links (e.g., the connection 210 and the connection 215) without TDM.

In some cases, whether the UE 115-a may be capable of remaining in a low-power state (e.g., an energy-saving mode or energy efficient scheduling mode that includes gaps where the UE 115-a does not expect PDSCHs) while communicating via multiple connections may be based on a baseband sharing among respective service subscriptions 205 for the connections (e.g., the service subscription 205-a and the service subscription 205-b). For example, if the service subscription 205-a and the service subscription 205-b have separate basebands (e.g., do not share a baseband), the UE 115-a may remain in a low power state on one of the service subscriptions 205 even if the other subscription is not operating in accordance with the energy-saving mode. In another example, if the service subscription 205-a and the service subscription 205-b share a baseband, then whether the UE 115-a may be capable of remaining in a low power state on a respective service subscription 205 may be based on what is shared in the baseband. For example, if the service subscription 205-a and the service subscription 205-b share decoders, then if service subscription 205-a is not operating in accordance with the energy-saving mode, the service subscription 205-b can be bottlenecked and may drive the baseband to a highest power state since the decoders (e.g., decoders or de-mappers) can be overloaded. Further, in such cases, scheduling gaps may be unable to be guaranteed. Although, if the UE 115-a indicates the service subscription 205-a of the scheduling restrictions of the service subscription 205-b, the service subscription 205-a may be capable of abiding by the scheduling restrictions such that the UE 115-a can remain in the low power state.

In accordance with the techniques of the present disclosure, the UE 115-a may communicate with the network entity 105-a via the connection 210 (e.g., a first connection) and with the network entity 105-b via the connection 215 (e.g., a second connection) where the service subscription 205-b associated with the communications via the connection 215 are in accordance with an energy-saving mode. Moreover, in such descriptions, the UE 115-a may be connected to the network entity 105-a via a single CC and connected with the network entity 105-b via a single CC. However, it should be understood by one having ordinary skill in the art that the techniques of the present disclosure described herein may apply to the UE 115-a being connected to network entities (e.g., the network entity 105-a, the network entity 105-b) via any quantity of CCs. The UE 115-a may further transmit, to at least one network entity 105 of one or more network entities 105 (e.g., the network entity 105-a, to the network entity 105-b, or to a network entity 105 that is associated with both the service subscription 205-a and the service subscription 205-b) a control signal 220 to align respective communication modes for the connection 210 associated with the service subscription 205-a and the connection 215 associated with the service subscription 205-b. The alignment of the respective communication modes may include communications via the connection 210 and communications via the connection 215 both being in accordance with the energy-saving mode or both not being in accordance with the energy-saving mode. The UE 115-a may then communicate with the network entity 105-a via the connection 210 and with the network entity 105-b via the connection 215 in accordance with the alignment of the respective communication modes for the connection 210 associated with the service subscription 205-a and the connection 215 associated with the service subscription 205-b.

In some examples, the UE 115-a may move or attempt to move from a first communication state (e.g., an RRC idle or RRC inactive state) to a second communication state (e.g., an RRC connected state) on the service subscription 205-a while the UE 115-a is associated with a limited throughput power mode (e.g., an energy-saving mode) on the service subscription 205-b. In response, the UE 115-a may transmit, to the network entity 105-b associated with the connection 215 and the service subscription 205-b, an indication of a capability of the UE 115-a to exit the energy-saving mode for the connection 215 and the service subscription 205-b based on the UE 115-a moving from the first communication state to the second communication state on the connection 210 associated with the service subscription 205-a. In such case, the UE 115-a may transmit the control signal 220 indicating for an alignment of the respective communications modes that includes the communications via the connection 210 and the communications via the connection 215 both not being in accordance with the energy-saving mode based on an exit of the energy-saving mode for the second connection.

In some examples, the UE 115-a may consider the activation of the service subscription 205-a as an event to transition to a high peak throughput state (e.g., a feedback without a feedback timeline relaxation, where the UE 115-a can be scheduled without gaps, and where a peak throughput is supported). In such cases, via the control signal 220, the UE 115-a may indicate for the network entity 105-b associated with the service subscription 205-b to transition back to a higher power state. Moreover, the UE 115-a may transmit the control signal 220 via a UAI message, an uplink control information (UCI) message, a MAC-control element (MAC-CE), a random access message as part of a random access channel (RACH) procedure (e.g., a Message A of a two-step RACH procedure, a Message 1 or 3 of a four-step RACH procedure, an ACK for a Message 4 of a four-step RACH procedure, or an RRC Connection Configuration (or Reconfiguration) Complete message), or any combination thereof. Additionally, or alternatively, the UE 115-a may utilize an additional logical channel identifier (LCID) to indicate to the network entity 105-a that the network entity 105-b is within an energy-saving mode (e.g., a low power mode with energy efficient scheduling). In some cases, when transmitting the control signal 220 to the network entity 105-b, the UE 115-a may refrain from indicating a reason for the exit of the energy-saving mode. In some other cases, the UE 115-a may indicate a reason for exiting the energy-saving mode. For example, the UE 115-a may indicate that the connection 210 is transitioning between communication states which may result in the connection 215 being unable to remain in the energy-saving mode. Additionally, or alternatively, there may be an applicability time for when the UE 115-a should exit the energy-saving mode and operate at a full peak throughput level.

In another example, rather than exiting or leaving the energy-saving mode, if the UE 115-a is within the energy-saving mode (e.g., a limited throughput lower power mode) on the service subscription 205-b, the UE 115-a may indicate the energy-saving mode to the network entity 105-a associated with the service subscription 205-a via uplink signaling. Thus, the UE 115-a may remain within the energy-saving mode with the service subscription 205-b. Further, to indicate the energy-saving mode, the UE 115-a may transmit, via the control signal 220 to the network entity 105-a associated with the service subscription 205-a and the connection 210, an indication that the communications via the service subscription 205-b with the network entity 105-b are in accordance with the energy-saving mode.

In some cases, the UE 115-a may also transmit, via the control signal 220, configuration information for the energy-saving mode. The configuration information may include an indication of a relaxed feedback timeline for the communications on the connection 215 via the service subscription 205-b. Moreover, the configuration may indicate that the network entity 105-b should maintain the same relaxed feedback timeline. A feedback timeline may refer to a duration after a downlink transmission (e.g., a PDSCH) that the UE 115-a has to transmit an uplink feedback indication (e.g., a HARQ-ACK/NACK message). Moreover, while in an energy-saving mode, a network entity 105 may relax the feedback timeline to give a UE 115 additional processing time for downlink messages before the UE 115 is expected to transmit the feedback indication, thus reducing the power consumption of the UE 115. The configuration information may indicate one or more slots or subframes (e.g., durations) that the UE 115-a is not expected to be scheduled with communications via the connection 215 using the service subscription 205-b. For example, the configuration information may indicate one or more active periods during which the UE 115-a is available to be scheduled for one or more shared channel communications (e.g., PDSCHs) via the connection 215, one or more scheduling gaps during which the UE is not to be scheduled for shared channel communications via the connection 215, or both.

Additionally, or alternatively, whenever the UE 115-a is scheduled with communications via the connection 210 using the service subscription 205-a, there may be a second peak or maximum throughput threshold that the UE 115-a should refrain from exceeding. Further, the second peak throughput threshold may be different than the first peak throughput threshold. For example, the first peak throughput threshold as described herein may refer to a throughput threshold for the UE 115-a using the service subscription 205-b in accordance with the energy-saving mode such that the UE 115-a should refrain from exceeding the first peak throughput threshold in order to ensure energy savings. The second peak throughput threshold may refer to a budget left remaining from the first peak throughput threshold or the maximum schedule throughput while maintaining the energy-saving mode at the UE 115-a. That is, the network entity 105-a associated with the service subscription 205-a and the network entity 105-b associated with the service subscription 205-b may share a peak throughput threshold whenever the UE 115-a is schedule in the energy-saving mode. The network entity 105-a may also determine to reduce a quantity of MIMO layers, reduce a bandwidth, reduce a modulation and coding scheme (MCS), or any combination thereof along with relaxing a feedback timeline and avoiding scheduling transmissions during the scheduling gaps. Additionally, or alternatively, there may be an applicability time or timer that starts at the uplink transmission of the control signal 220 for the network entity 105-a associated with the service subscription 205-a to reduce the peak throughput low power to align with the energy-saving mode associated with the service subscription 205-b. In some examples, the applicability time, timer duration, or both may be predefined, signaled between the network entities 105 and the UE 115-a, negotiated between the network entities 105 and the UE 115-a, or any combination thereof.

In some cases, when the network entity 105-b associated with service subscription 205-b keeps the UE 115-a within the energy-saving mode for the service subscription 205-b, the network entity 105-a may comply with the restraints of the energy-saving mode. For example, the network entity 105-a may avoid scheduling communications via the connection 210 during the scheduling gaps of the energy-saving mode. Thus, the UE 115-a may be unavailable to be scheduled for one or more shared channel communications via the connection 210 and the connection 215 during the one or more scheduling gaps. In some other cases, the network entity 105-a may schedule communications via the connection 210 during the scheduling gaps while ensuring that a peak throughput threshold is unsatisfied. That is, the UE 115-a may be available to be scheduled for one or more shared channel communications via the connection 210 during the one or more scheduling gaps based on a throughput threshold for the connection 210. Thus, in accordance with the techniques of the present disclosure, the UE 115-a may be able to align the communications between the service subscription 205-a and the service subscription 205-b while maintaining a low power or energy-saving mode in at least one of the service subscriptions 205. Additionally, or alternatively, in accordance with the techniques of the present disclosure, if the traffic on a respective network entity 105 is relatively low priority traffic, the UE 115-a can request for a release of the corresponding connection. For example, if the UE 115-a is being scheduled in accordance with an energy-saving mode on the connection 215 and the traffic is relatively low priority traffic, the UE 115-a may transmit a request to the network entity 105-b requesting to be released from the connection 215 with the network entity 105-b.

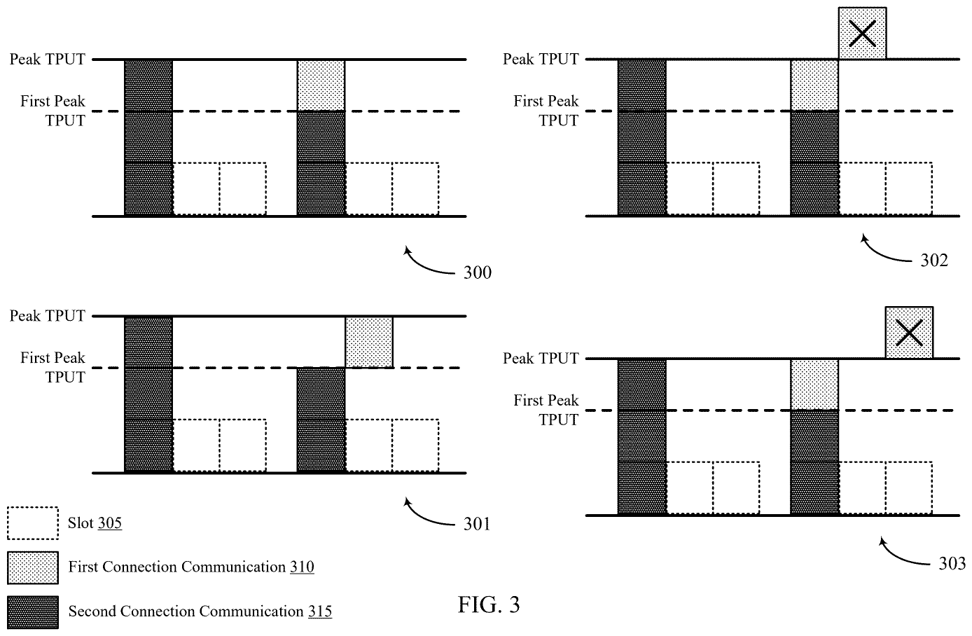

Further descriptions of the techniques of the present disclosure related to the network entity 105-a associated with the service subscription 205-a scheduling or refraining from scheduling communications on the connection 210 while the UE 115-a is within the energy-saving mode for communications via the connection 215 with the network entity 105-b associated with the service subscription 205-b may be described elsewhere herein, such as with reference to FIG. 3

FIG. 3 shows an example of a timing diagram 300, a timing diagram 301, a timing diagram 302, and a timing diagram 303 that supports energy efficient scheduling for multi-connection communications in accordance with one or more aspects of the present disclosure. The timing diagram 300, the timing diagram 301, the timing diagram 302, and the timing diagram 303 may may implement or be implemented by the wireless communications system 100, the wireless communications system 200, or both. For example, the timing diagram 300, the timing diagram 301, the timing diagram 302, and the timing diagram 303 may illustrate a UE 115 being scheduled with communications over one or more slots 305 where the communications include a set of first connection communications 310 and a set of second connection communications 315. The first connection communications 310 may be associated with communications from a network entity 105 connected to a UE 115 and operating without an energy-saving mode. The second connection communications 315 may be associated with communications from a network entity 105 connected to a UE 115 and operating within an energy-saving mode.

As illustrated herein, the dark shaded boxes representing the second connection communications 315 may be associated with communications via a second connection in accordance with an energy-saving mode (e.g., communications via the connection 215 and the service subscription 205-b described with reference to FIG. 2). Further, the light shaded boxes representing the first connection communications 310 may be associated with communications via a first connection that are not in accordance with an energy-saving mode (e.g., communications via the connection 210 and the service subscription 205-a described with reference to FIG. 2). Moreover, the dashed boxes may represent the slots 305 that are associated with scheduling gaps of an energy-saving mode.

As shown on the left of the timing diagram 300, the timing diagram 301, the timing diagram 302, and the timing diagram 303, if a UE 115 is configured for communications via a single connection and corresponding service subscription, the UE 115 may be capable of receiving communications up to a peak throughput threshold (e.g., the top solid line illustrated herein). That is, when a UE 115 is configured with a single service subscription and the UE 115 is not operating in accordance with an energy-saving mode, the UE 115 may utilize the full peak throughput for communications on the single service subscription. The right side of the timing diagram 300, the timing diagram 301, the timing diagram 302, and the timing diagram 303 may illustrate a scenario of a UE 115 being configured with a first service subscription associated with the first connection communications 310 and a second service subscription associated with second connection communications 315. As shown via the dotted line, the UE 115 may be restricted by a first peak throughput level for the second connection communications 315 when the UE 115 is in an energy-saving mode via a second connection.

In some examples, as illustrated via the timing diagram 300, a network entity 105 associated with the first connection communications 310 may be configured to avoid scheduling during the slots 305 of the scheduling gaps associated with the energy-saving mode for the second connection communications 315. As such, as the timing diagram 300 illustrates that three downlink communications is the maximum quantity before satisfying the peak throughput threshold. Thus, having the UE 115 receive a maximum of two messages via the second connection communications 315 and one message via the first connection communications 310 may ensure that the peak throughput threshold is not exceeded. Additionally, or alternatively, if the scheduling gaps of the energy-saving mode associated with the second connection communications 315 are deterministic (e.g., inserted semi-statically), the UE 115 may indicate to the network entity 105 associated with the first connection communications 310 an indication of a duty cycle. In some cases, the indication of the duty cycle may include an indication of one or more periods during which the UE 115 is not to be scheduled with the first connection communications 310 (e.g., communications via a first connection). The duty cycle may also be based on a common reference time that is predefined, negotiated, or signaled between a UE 115 and one or more network entities 105.

Further, in some cases, as described herein, the network entity 105 associated with the first connection communications 310 may schedule communications during the slots 305 of the scheduling gaps in accordance with one or more restrictions. For example, even though the network entity 105 may be capable of scheduling the first connection communications 310 during the slots 305 of the scheduling gaps associated with an energy-saving, the UE 115 may still be restricted by the peak throughput threshold. Further, as described elsewhere herein with reference to FIG. 2, to allow the UE 115 to remain in an energy-saving mode, one or more network entities 105 associated with the first connection communications 310, the second connection communications 315, or both (e.g., both at separate network entities 105 or the same network entity 105) may receive control signaling (e.g., assistance information) indicating information associated with the energy-saving mode. Once the network entity 105 receives the control signaling, the network entity 105 associated with the second connection communications 315 may be expected to schedule the UE 115 during an active time of a duty cycle and within the first peak throughput that is indicated by the UE 115 (e.g., illustrated via the dashed line). In some cases, the network entity 105 associated with the first connection communications 310 may determine to schedule the UE 115 during a slot that is configured for a scheduling gap in the energy-saving mode. In such cases, the network entity 105 be expected to ensure that no more than two downlink communications (e.g., PDSCHs) are scheduled within the second maximum limited throughput in the duty cycle (e.g., duty cycle=on duration+gap). Moreover, the network entity 105 associated with the first connection communications 310 may be expected to assume that the network entity 105 associated with the second connection communications 315 has utilized the entire throughput budget allocated to the network entity 105 associated with the second connection communications 315.

For example, as illustrated via the timing diagram 301, the UE 115 may be scheduled with the second connection communications 315 in a first slot 305 and the UE 115 may satisfy a first peak throughput threshold. That is, since the second connection communications 315 are associated with an energy-saving mode, the UE 115 may be restricted to receiving the second connection communications 315 during a first slot 305 up to the first peak throughput that is associated with the energy-saving mode. For example, as described elsewhere herein with reference to FIG. 2, the UE 115 may have a first peak throughput threshold for an energy-saving mode that a network entity 105 may refrain from exceeding when scheduling communications on a connection that is associated with the energy-saving mode. Moreover, for a connection that is not associated with the energy-saving mode, a network entity 105 may be capable of scheduling communications above the first peak throughput threshold as long as the sum of the throughput of all the messages refrain from exceeding a peak throughput threshold.

Thus, in accordance with the techniques of the present disclosure, a network entity associated with the first connection communications 310 may schedule communications during slots 305 that are scheduling gaps. For example, as illustrated via the timing diagram 301, a UE 115 may be scheduled with the second connection communications 315 in a first slot and with the first connection communications 310 in a second slot 305 such that a peak throughput threshold is satisfied but not exceeded. In such cases, the UE 115 may be unable to be scheduled with any communications during a third slot as the UE 115 may expect to use the third slot 305 to process the first connection communications 310 and the second connection communications 315.

In some examples, as illustrated via the timing diagram 302 and the timing diagram 303, the UE 115 may be scheduled with communications that results in the peak throughput threshold being exceeded. In the timing diagram 302 and the timing diagram 303, the UE 115 may be scheduled with both the first connection communications 310 and the second connection communications 315 during a first slot 305 such that the peak throughput threshold is satisfied. Thus, in such cases, the UE 115 may expect to utilize both a second slot 305 and a third slot 305 to process the first connection communications 310 and the second connection communications 315. For example, since the UE 115 may be in an energy-saving mode in at least one connection, the UE 115 may have a relaxed feedback timeline to ensure that the UE 115 can reduce the power consumption of the UE 115 associated with processing and providing feedback to downlink messages. However, if the UE 115 is scheduled with communications that results in the peak throughput threshold being exceeded, the UE 115 may be unable to successfully process all the first connection communications 310 and all the second connection communications 315.

In some examples, based on unsuccessfully processing communications, the UE 115 may have to request for a retransmission of data which may result in an increase in communication latency within a wireless communication system. Moreover, some forms of communications may expect high reliability and low latency (e.g., such as extended reality (XR) communications) and an increase in latency may reduce the reliability and efficiency of the wireless communications. Additionally, or alternatively, the increase in latency may result in wireless communication failures that can cause the UE 115 to declare radio link failures which can introduce further latency associated with the UE 115 reestablishing a connection with a network entity 105. Thus, as shown in the timing diagram 302 and the timing diagram 303, having first connection communications 310 scheduled both in the first slot 305 and in the second slot 305 or in the third slot 305 may result in the UE 115 being unable to remain in an energy-saving mode, thus resulting in an increase in power consumption at the UE 115 which may be detrimental to low-power UEs 115.

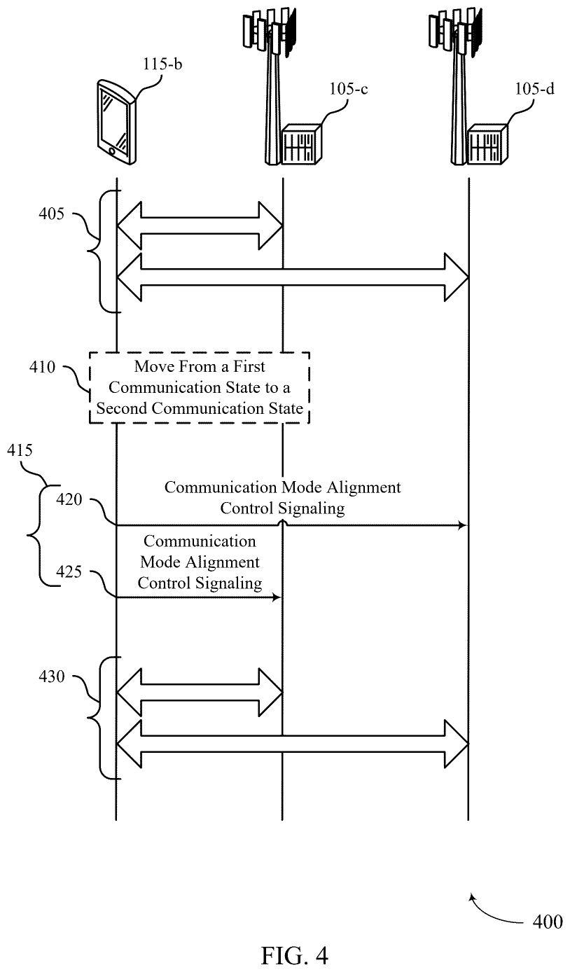

To avoid such scenarios, in accordance with the techniques of the present disclosure, a UE 115 may indicate the configuration information of an energy-saving mode to network entities 105. For example, the UE 115 may be in a first communication mode for a first connection with a network entity 105 that is associated with a first service subscription and in a second communication mode (e.g., an energy-saving mode) for a second connection with a network entity 105 associated with a second service subscription. In such examples, the UE 115 may indicate information associated with the energy-saving mode to the network entity 105 associated with the first connection such that the network entity 105 is capable of scheduling the UE 115 with communications that enables the UE 115 to remain in the energy-saving mode on the second connection. Therefore, the techniques of the present disclosure may ensure that network entities 105 associated with different service subscriptions that are communicating with the same UE 115 can be coordinated to improve the efficiency and reliability of wireless communications. Further descriptions of the techniques of the present disclosure may be described elsewhere herein, such as with reference to FIG. 4.

FIG. 4 shows an example of a process flow 400 that supports energy efficient scheduling for multi-connection communications in accordance with one or more aspects of the present disclosure. In some examples, the process flow 400 may implement or be implemented by the wireless communications system 100, the wireless communications system 200, the timing diagram 300, the timing diagram 301, the timing diagram 302, the timing diagram 303, or any combination thereof. For example, the process flow 400 may include a UE 115-b, a network entity 105-c associated with a first connection (e.g., a first service subscription), a network entity 105-d associated with a second connection (e.g., a second service subscription), which may be examples of devices described herein with reference to FIGS. 1 and 2.

In the following description of the process flow 400, the operations between the UE 115-b, the network entity 105-c, and the network entity 105-d may be performed in different orders or at different times. Some operations may also be left out of the process flow 400, or other operations may be added. Although the UE 115-b, the network entity 105-c, and the network entity 105-d are shown performing the operations of the process flow 400, some aspects of some operations may also be performed by one or more other wireless devices.

At 405, the UE 115-b may communicate, via a first connection (e.g., a connection with the network entity 105-c) and a second connection (e.g., a connection with the network entity 105-d), with one or more network entities (e.g., the network entity 105-c and the network entity 105-d or a single network entity 105), where communications via the second connection (e.g., with the network entity 105-d) are in accordance with an energy-saving mode. In some examples, the energy-saving mode indicates a scheduling configuration that is associated with a first active period during which the UE 115-b is scheduled to receive one or more shared channel communications, one or more scheduling gaps that occur after the first active period and during which the UE 115-b is not to be scheduled for shared channel communications, and a second active period that occurs after the one or more scheduling gaps. Further, the first connection (and the network entity 105-c) may be associated with a first service subscription (e.g., a first SIM) and the second connection (and the network entity 105-d) may be associated with a second service subscription (e.g., a second SIM).

At 410, in some cases, the UE 115-b may move from a first communication state for the first connection to a second communication state for the first connection. For example, the UE 115-b may move from an RRC idle or RRC inactive state (e.g., a first communication state) to an RRC connected state (e.g., a second communication state).

At 415, the UE 115-b may transmit, to at least one network entity 105 of the one or more network entities 105 (e.g., the network entity 105-c or the network entity 105-d), control signaling to align respective communications modes for the first connection and the second connection. The alignment of the respective communications modes may include communications via the first connection and the communications via the second connection both being in accordance with the energy-saving mode or both not being in accordance with the energy-saving mode. In some examples, the UE 115-b may transmit, to the at least one network entity 105 of the one or more network entities 105, the control signaling via an uplink assistance information message, an uplink control information message, a MAC-CE message, a random access message, or any combination thereof.

At 420, in some examples, transmission of the control signaling to align the respective communication modes may include the UE 115-b transmitting, to the network entity 105 that is associated with the second connection (e.g., the network entity 105-d), an indication of a capability of the UE 115-b to exit the energy-saving mode for the second connection based on the UE 115-b moving from the first communication state to the second communication state on the first connection. Thus, the alignment of the respective communications modes indicated via the control signaling may indicate the communications via the first connection and the communications via the second connection both not being in accordance with the energy-saving mode based on an exit of the energy-saving mode for the second connection. In some cases, the alignment of the respective communications modes may also be associated with an applicability time for the capability of the UE 115-b to exit the energy-saving mode for the second connection.

At 425, in some other examples, transmission of the control signaling to align the respective communication modes may include the UE 115-b transmitting, to a network entity 105 associated with the first connection (e.g., the network entity 105-c), an indication that the communications via the second connection are in accordance with the energy-saving mode. In such examples, the UE 115-b may further transmit, to the network entity 105-c, configuration information for the energy-saving mode. In some cases, the configuration information for the energy-saving mode may indicate a feedback timeline for the second connection, one or more active periods during which the UE 115-b is available to be scheduled for one or more shared channel communications via the second connection, one or more scheduling gaps during which the UE 115-b is not to be scheduled for shared channel communications via the second connection, or any combination thereof. In some aspects, the UE 115-b may also be unavailable to be scheduled for one or more shared channel communications via the first connection during the one or more scheduling gaps. In some other aspects, the UE 115-b may be available to be scheduled for one or more shared channel communications via the first connection during the one or more scheduling gaps based on a throughput threshold for the first connection. In some cases, the UE 115-b may also transmit, to the at least one network entity (e.g., to the network entity 105-c) an indication of a duty cycle that includes one or more periods during which the UE 115-b is not to be scheduled for shared channel communications via the first connection. Further, the alignment for the communications via the first connection and the communications via the second connection to both be in accordance with the energy-saving mode may be associated with an applicability time, a timer duration, or both that are based on a time of transmission of the control signaling.

At 430, the UE 115-b may communicate, via the first connection and the second connection, with the one or more network entities (e.g., the network entity 105-c via the first connection and the network entity 105-d via the second connection) in accordance with the alignment of the respective communications modes for the first connection and the second connection.

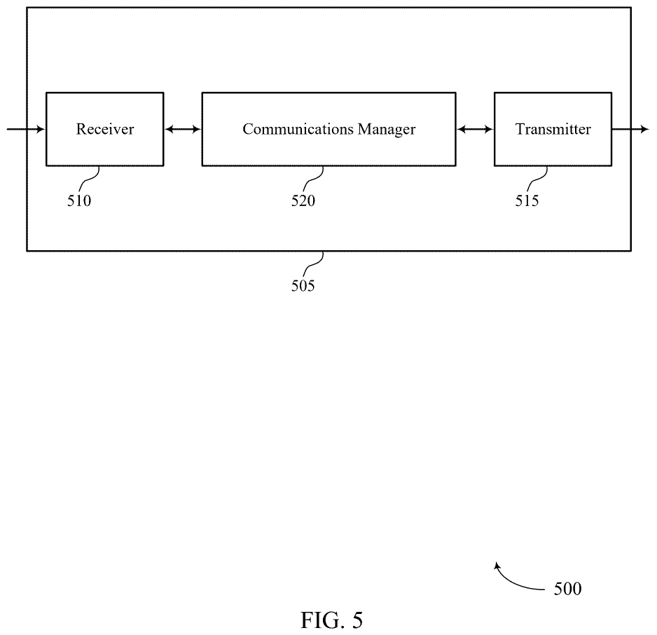

FIG. 5 shows a block diagram 500 of a device 505 that supports energy efficient scheduling for multi-connection communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to energy efficient scheduling for multi-connection communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to energy efficient scheduling for multi-connection communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of energy efficient scheduling for multi-connection communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for communicating, via a first connection and a second connection, with one or more network entities, where communications via the second connection are in accordance with an energy-saving mode. The communications manager 520 is capable of, configured to, or operable to support a means for transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode. The communications manager 520 is capable of, configured to, or operable to support a means for communicating, via the first connection and the second connection, with the one or more network entities in accordance with the alignment of the respective communications modes for the first connection and the second connection.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a UE 115 to align respective communication modes on two or more connections, one of which being in an energy-saving mode, to support reduced processing, reduced power consumption, and more efficient utilization of communication resources.

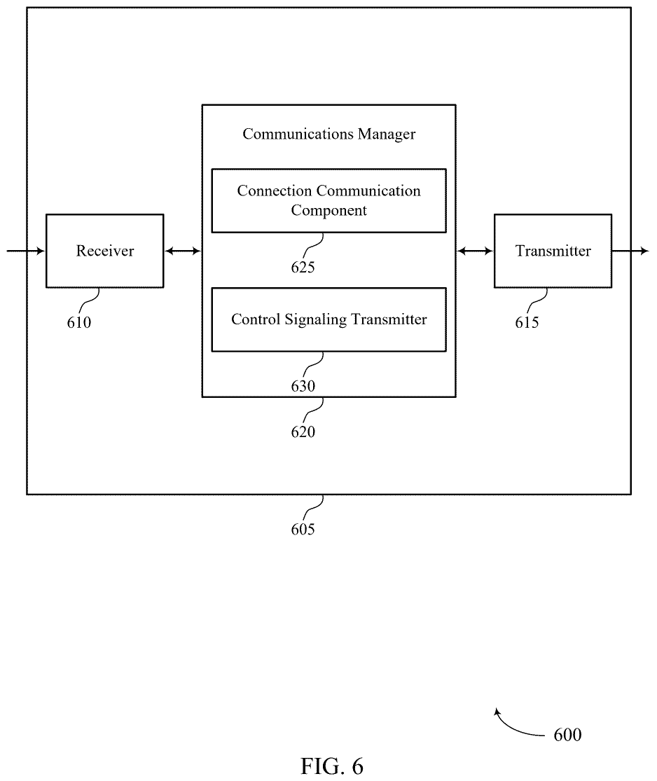

FIG. 6 shows a block diagram 600 of a device 605 that supports energy efficient scheduling for multi-connection communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to energy efficient scheduling for multi-connection communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy efficient scheduling for multi-connection communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of energy efficient scheduling for multi-connection communications as described herein. For example, the communications manager 620 may include a connection communication component 625 a control signaling transmitter 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The connection communication component 625 is capable of, configured to, or operable to support a means for communicating, via a first connection and a second connection, with one or more network entities, where communications via the second connection are in accordance with an energy-saving mode. The control signaling transmitter 630 is capable of, configured to, or operable to support a means for transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode. The connection communication component 625 is capable of, configured to, or operable to support a means for communicating, via the first connection and the second connection, with the one or more network entities in accordance with the alignment of the respective communications modes for the first connection and the second connection.

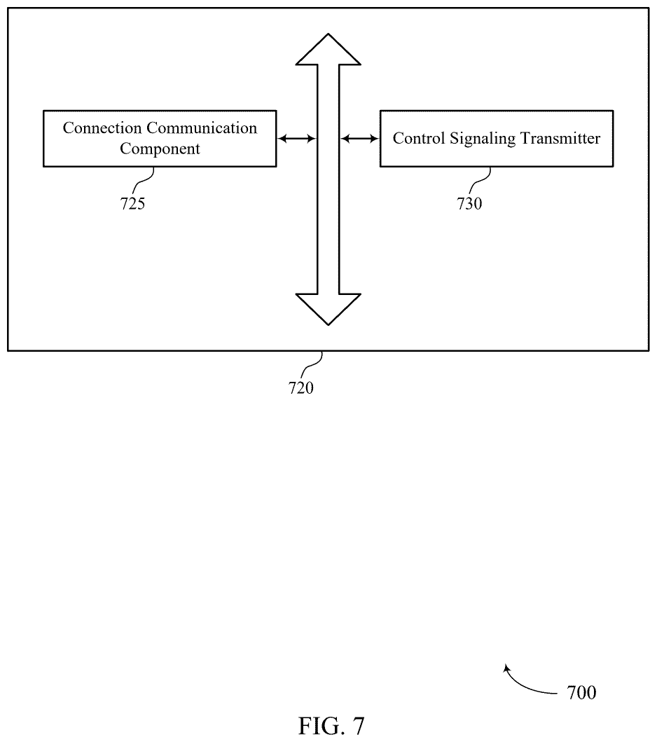

FIG. 7 shows a block diagram 700 of a communications manager 720 that supports energy efficient scheduling for multi-connection communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of energy efficient scheduling for multi-connection communications as described herein. For example, the communications manager 720 may include a connection communication component 725 a control signaling transmitter 730, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The connection communication component 725 is capable of, configured to, or operable to support a means for communicating, via a first connection and a second connection, with one or more network entities, where communications via the second connection are in accordance with an energy-saving mode. The control signaling transmitter 730 is capable of, configured to, or operable to support a means for transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode. In some examples, the connection communication component 725 is capable of, configured to, or operable to support a means for communicating, via the first connection and the second connection, with the one or more network entities in accordance with the alignment of the respective communications modes for the first connection and the second connection.

In some examples, to support transmitting the control signaling to align the respective communications modes, the control signaling transmitter 730 is capable of, configured to, or operable to support a means for transmitting, to a network entity associated with the second connection, an indication of a capability of the UE to exit the energy-saving mode for the second connection based on a change from a first communication state for the first connection to a second communication state for the first connection, the alignment of the respective communications modes including the communications via the first connection and the communications via the second connection both not being in accordance with the energy-saving mode based on an exit of the energy-saving mode for the second connection.

In some examples, the first communication state is an RRC idle state or an RRC inactive state. In some examples, the second communication state is an RRC connected state.

In some examples, the alignment of the respective communications modes is associated with an applicability time for the capability of the UE to exit the energy-saving mode for the second connection.

In some examples, to support transmitting the control signaling to align the respective communications modes, the control signaling transmitter 730 is capable of, configured to, or operable to support a means for transmitting, to the at least one network entity of the one or more network entities, an uplink assistance information message, an uplink control information message, a MAC-CE message, a random access message, or any combination thereof.

In some examples, to support transmitting the control signaling to align the respective communications modes, the control signaling transmitter 730 is capable of, configured to, or operable to support a means for transmitting, to a network entity associated with the first connection, an indication that the communications via the second connection are in accordance with the energy-saving mode.

In some examples, to support transmitting the control signaling to align the respective communications modes, the control signaling transmitter 730 is capable of, configured to, or operable to support a means for transmitting configuration information for the energy-saving mode, the configuration information for the energy-saving mode indicating a feedback timeline for the second connection, one or more active periods during which the UE is available to be scheduled for one or more shared channel communications via the second connection, one or more scheduling gaps during which the UE is not to be scheduled for shared channel communications via the second connection, or any combination thereof. In some examples, the UE is also unavailable to be scheduled for one or more shared channel communications via the first connection during the one or more scheduling gaps. In some examples, the UE is available to be scheduled for one or more shared channel communications via the first connection during the one or more scheduling gaps based on a throughput threshold for the first connection.

In some examples, to support transmitting the control signaling to align the respective communications modes, the control signaling transmitter 730 is capable of, configured to, or operable to support a means for transmitting, to the at least one network entity, an indication of a duty cycle including one or more periods during which the UE is not to be scheduled for shared channel communications via the first connection.

In some examples, the energy-saving mode indicates a scheduling configuration that is associated with a first active period during which the UE is scheduled to receive one or more shared channel communications, one or more scheduling gaps that occur after the first active period and during which the UE is not to be scheduled for shared channel communications, and a second active period that occurs after the one or more scheduling gaps.

In some examples, the alignment for the communications via the first connection and the communications via the second connection to both be in accordance with the energy-saving mode is associated with an applicability time, a timer duration, or both that are based on a time of transmission of the control signaling.

In some examples, the first connection is associated with a first service subscription and the second connection is associated with a second service subscription.

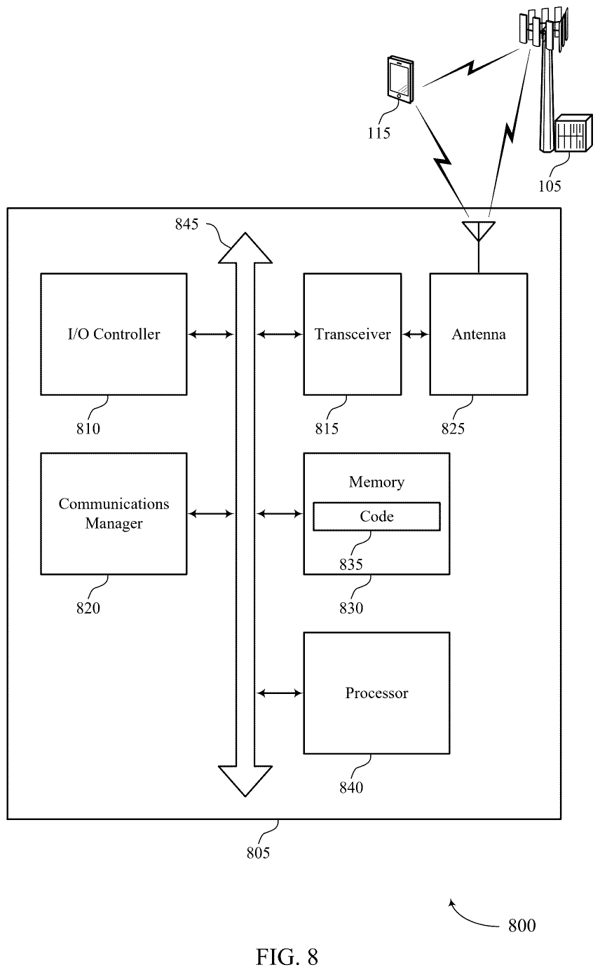

FIG. 8 shows a diagram of a system 800 including a device 805 that supports energy efficient scheduling for multi-connection communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting energy efficient scheduling for multi-connection communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for communicating, via a first connection and a second connection, with one or more network entities, where communications via the second connection are in accordance with an energy-saving mode. The communications manager 820 is capable of, configured to, or operable to support a means for transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode. The communications manager 820 is capable of, configured to, or operable to support a means for communicating, via the first connection and the second connection, with the one or more network entities in accordance with the alignment of the respective communications modes for the first connection and the second connection.

By including or configuring the communications manager 820 in accordance with examples as described herein, the device 805 may support techniques for a UE 115 to align respective communication modes on two or more connections, one of which being in an energy-saving mode, to support improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of energy efficient scheduling for multi-connection communications as described herein, or the at least one processor 840 and the at least one memory 830 may be otherwise configured to, individually or collectively, perform or support such operations.

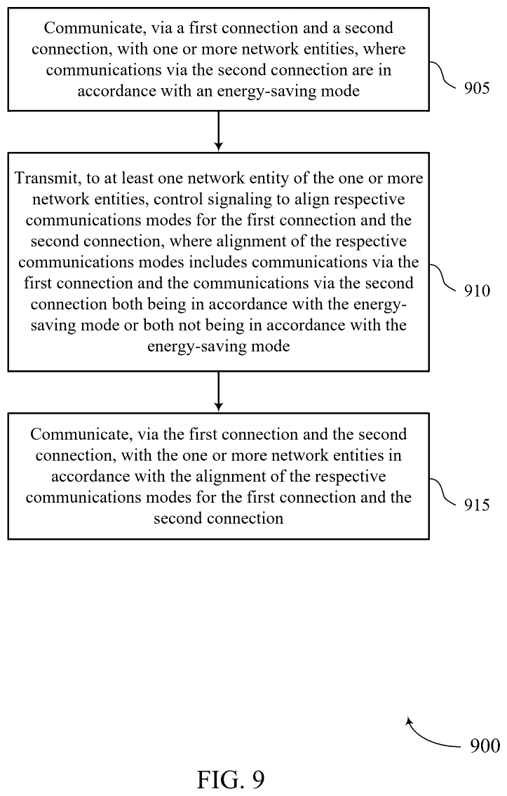

FIG. 9 shows a flowchart illustrating a method 900 that supports energy efficient scheduling for multi-connection communications in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include communicating, via a first connection and a second connection, with one or more network entities, where communications via the second connection are in accordance with an energy-saving mode. The operations of 905 may be performed in accordance with examples as disclosed herein. In some examples, aspects of the operations of 905 may be performed by a connection communication component 725 as described with reference to FIG. 7. Additionally or alternatively, means for performing 905 may, but not necessarily, include, for example, antenna 825, transceiver 815, communications manager 820, memory 830 (including code 835), processor 840, and/or bus 845.

At 910, the method may include transmitting, to at least one network entity of the one or more network entities, control signaling to align respective communications modes for the first connection and the second connection, where alignment of the respective communications modes includes communications via the first connection and the communications via the second connection both being in accordance with the energy-saving mode or both not being in accordance with the energy-saving mode. The operations of 910 may be performed in accordance with examples as disclosed herein. In some examples, aspects of the operations of 910 may be performed by a control signaling transmitter 730 as described with reference to FIG. 7. Additionally or alternatively, means for performing 910 may, but not necessarily, include, for example, antenna 825, transceiver 815, communications manager 820, memory 830 (including code 835), processor 840, and/or bus 845.

At 915, the method may include communicating, via the first connection and the second connection, with the one or more network entities in accordance with the alignment of the respective communications modes for the first connection and the second connection. The operations of 915 may be performed in accordance with examples as disclosed herein. In some examples, aspects of the operations of 915 may be performed by a connection communication component 725 as described with reference to FIG. 7. Additionally or alternatively, means for performing 915 may, but not necessarily, include, for example, antenna 825, transceiver 815, communications manager 820, memory 830 (including code 835), processor 840, and/or bus 845.

The following provides an overview of aspects of the present disclosure:

Aspect 1: A method for wireless communications at a UE, comprising: communicating, via a first connection and a second connection, with one or more network entities, wherein communications via the second connection are in accordance with an energy-saving mode; transmitting, to at least one network entity of the one or more network entities, control signaling to align respective communications modes for the first connection and the second connection, wherein alignment of the respective communications modes comprises communications via the first connection and the communications via the second connection both being in accordance with the energy-saving mode or both not being in accordance with the energy-saving mode; and communicating, via the first connection and the second connection, with the one or more network entities in accordance with the alignment of the respective communications modes for the first connection and the second connection.

Aspect 2: The method of aspect 1, wherein transmitting the control signaling to align the respective communications modes comprises: transmitting, to a network entity associated with the second connection, an indication of a capability of the UE to exit the energy-saving mode for the second connection based at least in part on a change from a first communication state for the first connection to a second communication state for the first connection, the alignment of the respective communications modes comprising the communications via the first connection and the communications via the second connection both not being in accordance with the energy-saving mode based at least in part on an exit of the energy-saving mode for the second connection.

Aspect 3: The method of aspect 2, wherein: the first communication state is a radio resource control (RRC) idle state or an RRC inactive state, and the second communication state is an RRC connected state.

Aspect 4: The method of any of aspects 2 through 3, wherein the alignment of the respective communications modes is associated with an applicability time for the capability of the UE to exit the energy-saving mode for the second connection.

Aspect 5: The method of any of aspects 1 through 4, wherein transmitting the control signaling to align the respective communications modes comprises: transmitting, to the at least one network entity of the one or more network entities, an uplink assistance information message, an uplink control information message, a medium access control (MAC)-control element (CE) message, a random access message, or any combination thereof.

Aspect 6: The method of any of aspects 1 through 5, wherein transmitting the control signaling to align the respective communications modes comprises: transmitting, to a network entity associated with the first connection, an indication that the communications via the second connection are in accordance with the energy-saving mode.

Aspect 7: The method of aspect 6, wherein transmitting the control signaling to align the respective communications modes comprises: transmitting configuration information for the energy-saving mode, the configuration information for the energy-saving mode indicating a feedback timeline for the second connection, one or more active periods during which the UE is available to be scheduled for one or more shared channel communications via the second connection, one or more scheduling gaps during which the UE is not to be scheduled for shared channel communications via the second connection, or any combination thereof.

Aspect 8: The method of aspect 7, wherein the UE is also unavailable to be scheduled for one or more shared channel communications via the first connection during the one or more scheduling gaps.

Aspect 9: The method of aspect 7, wherein the UE is available to be scheduled for one or more shared channel communications via the first connection during the one or more scheduling gaps based at least in part on a throughput threshold for the first connection.

Aspect 10: The method of any of aspects 1 through 9, wherein transmitting the control signaling to align the respective communications modes comprises: transmitting, to the at least one network entity, an indication of a duty cycle comprising one or more periods during which the UE is not to be scheduled for shared channel communications via the first connection.

Aspect 11: The method of any of aspects 1 through 10, wherein the energy-saving mode indicates a scheduling configuration that is associated with a first active period during which the UE is scheduled to receive one or more shared channel communications, one or more scheduling gaps that occur after the first active period and during which the UE is not to be scheduled for shared channel communications, and a second active period that occurs after the one or more scheduling gaps.

Aspect 12: The method of any of aspects 1 through 11, wherein the alignment for the communications via the first connection and the communications via the second connection to both be in accordance with the energy-saving mode is associated with an applicability time, a timer duration, or both that are based at least in part on a time of transmission of the control signaling.

Aspect 13: The method of any of aspects 1 through 12, wherein the first connection is associated with a first service subscription and the second connection is associated with a second service subscription.

Aspect 14: A UE for wireless communications, comprising one or more memories storing processor-executable code, a transceiver, and one or more processors coupled with the one or more memories and the transceiver and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors configured to cause the UE to:
communicate, via the transceiver and via a first connection and a second connection, with one or more network entities, wherein communications via the second connection are in accordance with an energy-saving mode;
transmit, via the transceiver, to at least one network entity of the one or more network entities, control signaling to align respective communications modes for the first connection and the second connection, wherein alignment of the respective communications modes comprises communications via the first connection and the communications via the second connection both being in accordance with the energy-saving mode or both not being in accordance with the energy-saving mode; and
communicate, via the transceiver and via the first connection and the second connection, with the one or more network entities in accordance with the alignment of the respective communications modes for the first connection and the second connection.

2. The UE of claim 1, wherein, to transmit the control signaling to align the respective communications modes, the one or more processors are configured to cause the UE to:
transmit, to a network entity associated with the second connection, an indication of a capability of the UE to exit the energy-saving mode for the second connection based at least in part on a change from a first communication state for the first connection to a second communication state for the first connection, the alignment of the respective communications modes comprising the communications via the first connection and the communications via the second connection both not being in accordance with the energy-saving mode based at least in part on an exit of the energy-saving mode for the second connection.

3. The UE of claim 2, wherein:
the first communication state is a radio resource control (RRC) idle state or an RRC inactive state, and
the second communication state is an RRC connected state.

4. The UE of claim 2, wherein the alignment of the respective communications modes is associated with an applicability time for the capability of the UE to exit the energy-saving mode for the second connection.

5. The UE of claim 1, wherein, to transmit the control signaling to align the respective communications modes, the one or more processors are configured to cause the UE to:
transmit, to the at least one network entity of the one or more network entities, an uplink assistance information message, an uplink control information message, a medium access control (MAC)-control element (CE) message, a random access message, or any combination thereof.

6. The UE of claim 1, wherein, to transmit the control signaling to align the respective communications modes, the one or more processors are configured to cause the UE to:
transmit, to a network entity associated with the first connection, an indication that the communications via the second connection are in accordance with the energy-saving mode.

7. The UE of claim 6, wherein, to transmit the control signaling to align the respective communications modes, the one or more processors are configured to cause the UE to:
transmit configuration information for the energy-saving mode, the configuration information for the energy-saving mode indicating a feedback timeline for the second connection, one or more active periods during which the UE is available to be scheduled for one or more shared channel communications via the second connection, one or more scheduling gaps during which the UE is not to be scheduled for shared channel communications via the second connection, or any combination thereof.

8. The UE of claim 7, wherein the UE is also unavailable to be scheduled for one or more shared channel communications via the first connection during the one or more scheduling gaps.

9. The UE of claim 7, wherein the UE is available to be scheduled for one or more shared channel communications via the first connection during the one or more scheduling gaps based at least in part on a throughput threshold for the first connection.

10. The UE of claim 1, wherein, to transmit the control signaling to align the respective communications modes, the one or more processors are configured to cause the UE to:
transmit, to the at least one network entity, an indication of a duty cycle comprising one or more periods during which the UE is not to be scheduled for shared channel communications via the first connection.

11. The UE of claim 1, wherein the energy-saving mode indicates a scheduling configuration that is associated with a first active period during which the UE is scheduled to receive one or more shared channel communications, one or more scheduling gaps that occur after the first active period and during which the UE is not to be scheduled for shared channel communications, and a second active period that occurs after the one or more scheduling gaps.

12. The UE of claim 1, wherein the alignment for the communications via the first connection and the communications via the second connection to both be in accordance with the energy-saving mode is associated with an applicability time, a timer duration, or both that are based at least in part on a time of transmission of the control signaling.

13. The UE of claim 1, wherein the first connection is associated with a first service subscription and the second connection is associated with a second service subscription.

14. A method for wireless communications by a user equipment (UE), comprising:
communicating, via a first connection and a second connection, with one or more network entities, wherein communications via the second connection are in accordance with an energy-saving mode;
transmitting, to at least one network entity of the one or more network entities, control signaling to align respective communications modes for the first connection and the second connection, wherein alignment of the respective communications modes comprises communications via the first connection and the communications via the second connection both being in accordance with the energy-saving mode or both not being in accordance with the energy-saving mode; and
communicating, via the first connection and the second connection, with the one or more network entities in accordance with the alignment of the respective communications modes for the first connection and the second connection.

15. The method of claim 14, wherein transmitting the control signaling to align the respective communications modes comprises:
transmitting, to a network entity associated with the second connection, an indication of a capability of the UE to exit the energy-saving mode for the second connection based at least in part on a change from a first communication state for the first connection to a second communication state for the first connection, the alignment of the respective communications modes comprising the communications via the first connection and the communications via the second connection both not being in accordance with the energy-saving mode based at least in part on an exit of the energy-saving mode for the second connection.

16. The method of claim 14, wherein transmitting the control signaling to align the respective communications modes comprises:
transmitting, to a network entity associated with the first connection, an indication that the communications via the second connection are in accordance with the energy-saving mode.

17. The method of claim 14, wherein the energy-saving mode indicates a scheduling configuration that is associated with a first active period during which the UE is scheduled to receive one or more shared channel communications, one or more scheduling gaps that occur after the first active period and during which the UE is not to be scheduled for shared channel communications, and a second active period that occurs after the one or more scheduling gaps.

18. A non-transitory computer-readable medium storing code for wireless communications, the code comprising instructions executable by one or more processors to:
communicate, via user equipment (UE) and via a first connection and a second connection, with one or more network entities, wherein communications via the second connection are in accordance with an energy-saving mode;
transmit, to at least one network entity of the one or more network entities, control signaling to align respective communications modes for the first connection and the second connection, wherein alignment of the respective communications modes comprises communications via the first connection and the communications via the second connection both being in accordance with the energy-saving mode or both not being in accordance with the energy-saving mode; and
communicate, via the first connection and the second connection, with the one or more network entities in accordance with the alignment of the respective communications modes for the first connection and the second connection.

19. The non-transitory computer-readable medium of claim 18, wherein, to transmit the control signaling to align the respective communications modes, the instructions are executable by the one or more processors to:
transmit, to a network entity associated with the second connection, an indication of a capability of the UE to exit the energy-saving mode for the second connection based at least in part on a change from a first communication state for the first connection to a second communication state for the first connection, the alignment of the respective communications modes comprising the communications via the first connection and the communications via the second connection both not being in accordance with the energy-saving mode based at least in part on an exit of the energy-saving mode for the second connection.

20. The non-transitory computer-readable medium of claim 18, wherein, to transmit the control signaling to align the respective communications modes, the instructions are executable by the one or more processors to:
transmit, to a network entity associated with the first connection, an indication that the communications via the second connection are in accordance with the energy-saving mode.
